(19) United States
(12) Patent Application Publication
(10) Pub. No.: US 2015/0046563 A1
(43) Pub. Date: Feb. 12, 2015

(54) ARITHMETIC PROCESSING DEVICE, ITS ARITHMETIC PROCESSING METHOD, AND STORAGE MEDIUM STORING ARITHMETIC PROCESSING PROGRAM

(71) Applicant: Tomoyoshi Kobori, Tokyo (JP)

(72) Inventor: Tomoyoshi Kobori, Tokyo (JP)

(73) Assignee: NEC CORPORATION, Minato-ku, Tokyo (JP)

(21) Appl. No.: 14/386,248

(22) PCT Filed: Feb. 13, 2013
(86) PCT No.: PCT/JP2013/000762

§ 371 Date: Sep. 18, 2014

(30) Foreign Application Priority Data
Mar. 30, 2012 (JP) 2012-079359

(51) Int. Cl. H04L 29/12

(52) U.S. Cl. CPC H04L 61/6009
USPC 709/217

(57) ABSTRACT

An arithmetic processing device includes a first storage for storing processing contents in a state where the processing contents are associated with addresses, a second storage for storing each of the addresses of the processing contents stored in the first storage, a holding portion, a reading portion-for successively reading the addresses stored in the second storage and outputting the read addresses to the holding portion, and an execution portion for reading the processing content corresponding to the address output from the holding portion from the first storage and executing the read processing content. When the holding portion holds no address, the holding portion temporarily holds the address read by the reading portion and outputs the held address, whereas when the holding portion holds the address, the holding portion waits for completion of the execution of the processing content by the execution portion and outputs the held address after the completion of the execution.

### TECHNICAL FIELD

The present invention relates to, for example, an arithmetic processing device that switches the type of processing for a plurality of users or tasks by using a parameter(s) existing for each user or each task, its arithmetic processing method, and an arithmetic processing program.

### BACKGROUND ART

Collectively processing data transmitted from a number of users in a server, a base station, or the like has been commonly practiced. Therefore, various processing methods for efficiently processing such a plurality of data have been proposed (see, for example, Patent Literature 1).

Incidentally, in the above-described data processing, there are cases where the processing content is changed according to the parameter(s) of user data. In such cases, it is necessary to perform control for the switching among users, thus increasing its instruction execution time.

To cope with this problem, arithmetic processing devices capable of reducing overhead such as conditional branching and parameter analysis by providing an instruction(s) to an arithmetic unit for executing processing in advance have been known (see, for example, Patent Literature 2).

### CITATION LIST

### Patent Literature

Patent Literature 1: Japanese Unexamined Patent Application Publication No. H5-298099
Patent Literature 2: Japanese Unexamined Patent Application Publication No. H7-182155

### SUMMARY OF INVENTION

### Technical Problem

However, in the arithmetic processing device disclosed in the aforementioned Patent Literature 2, there is a possibility that when there are a number of users to each of which a small amount of data is assigned, the overhead due to the switching among each process cannot be sufficiently reduced and hence the overall calculation performance deteriorates.

### Solution to Problem

The present invention has been made to solve the above-described problem and a main object thereof is to provide an arithmetic processing device capable of reducing the overhead caused by the switching among each process and thereby improving the overall calculation performance, its arithmetic processing method, and an arithmetic processing program.

An aspect of the present invention for achieving the above-described object is an arithmetic processing device including: first storage means for storing a plurality of processing contents in a state where the plurality of processing contents are associated with addresses; second storage means for storing each of the addresses of the plurality of processing contents stored in the first storage means; holding means for temporarily holding the address; reading means for successively reading the addresses stored in the second storage means and outputting the read addresses to the holding means; and execution means for reading the processing content corresponding to the address output from the holding means from the first storage means and executing the read processing content, in which when the holding means holds no address, the holding means temporarily holds the address read by the reading means and outputs the held address, whereas when the holding means holds the address, the holding means waits for completion of the execution of the processing content by the execution means and outputs the held address after the completion of the execution.

Another aspect of the present invention for achieving the above-described object may be an arithmetic processing method for an arithmetic processing device, the arithmetic processing device including: first storage means for storing a plurality of processing contents in a state where the plurality of processing contents are associated with addresses; second storage means for storing each of the addresses of the plurality of processing contents stored in the first storage means; and holding means for temporarily holding the address,

the arithmetic processing method including: a step of successively reading the addresses stored in the second storage means and outputting the read addresses to the holding means; a step of reading the processing content corresponding to the address output from the holding means from the first storage means and executing the read processing content; and a step of, when the holding means holds no address, temporarily holding the read address and outputting the held address, and when the holding means holds the address, waiting for completion of the execution of the processing content and outputting the held address after the completion of the execution.

Another aspect of the present invention for achieving the above-described object may be an arithmetic processing program for an arithmetic processing device, the arithmetic processing device including: first storage means for storing a plurality of processing contents in a state where the plurality processing contents are associated with addresses; second storage means for storing each of the addresses of the plurality of processing contents stored in the first storage means; and holding means for temporarily holding the address,

the arithmetic processing program causing a computer to execute: a process of successively reading the addresses stored in the second storage means and outputting the read addresses to the holding means; a process of reading the processing content corresponding to the address output from the holding means from the first storage means and executing the read processing content; and a process of, when the holding means holds no address, temporarily holding the read address and outputting the held address, and when the holding means holds the address, waiting for completion of the execution of the processing content and outputting the held address after the completion of the execution.

### Advantageous Effects of Invention

According to the present invention, it is possible to provide an arithmetic processing device capable of reducing the overhead caused by the switching among each process and thereby improving the overall calculation performance, its arithmetic processing method, and an arithmetic processing program.

### BRIEF DESCRIPTION OF DRAWINGS

FIG. 1 is a block diagram showing a schematic system configuration of an arithmetic processing device according to a first exemplary embodiment of the present invention;

FIG. 2 shows an example of a structure of a special instruction USER_JUMP according to the first exemplary embodiment of the present invention;

FIG. 3 shows an example of a structure of a user table, a jump table, and an instruction memory according to the first exemplary embodiment of the present invention;

FIG. 4 is a block diagram showing a schematic system configuration of an arithmetic processing device according to a second exemplary embodiment of the present invention;

FIG. 5 shows an example of a structure of a special instruction USER_JUMP according to the second exemplary embodiment of the present invention;

FIG. 6 shows an example of a structure of a user table, a jump table, an FF, a COMP part, and an instruction memory according to the second exemplary embodiment of the present invention;

FIG. 7 is a block diagram showing a schematic system configuration of an arithmetic processing device according to a third exemplary embodiment of the present invention;

FIG. 8 shows an example of a structure of a special instruction USER_JUMP according to the third exemplary embodiment of the present invention;

FIG. 9 shows an example of a structure of a user table, a jump table, and an instruction memory according to a fourth exemplary embodiment of the present invention;

FIG. 10 shows an example of a structure of a user table, a jump table, an FF, a COMP part, and an instruction memory according to a fifth exemplary embodiment of the present invention; and

FIG. 11 is a functional block diagram of an arithmetic processing device according to an exemplary embodiment of the present invention.

### DESCRIPTION OF EMBODIMENTS

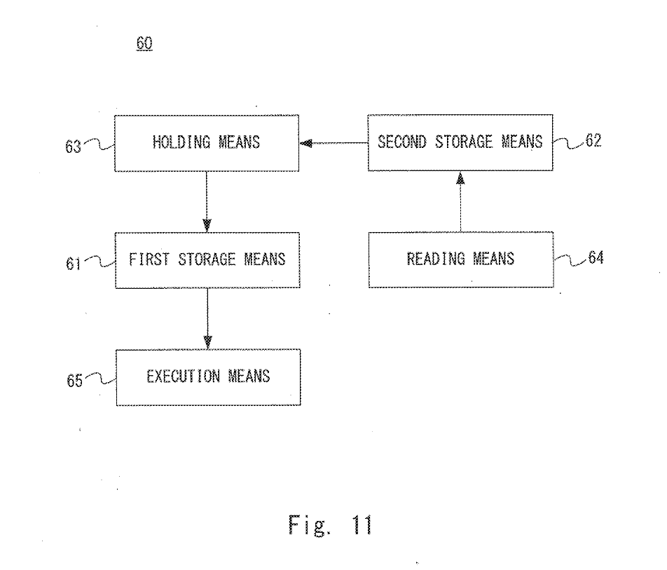

FIG. 11 is a functional block diagram of an arithmetic processing device according to an exemplary embodiment of the present invention. An arithmetic processing device 60 according to this exemplary embodiment includes first storage means 61 for storing a plurality of processing contents in a state where the plurality of processing contents are associated with addresses, second storage means 62 for storing each of the addresses of the plurality of processing contents stored in the first storage means 61, holding means 63 for temporarily holding the address, reading means 64 for successively reading the addresses stored in the second storage means 62 and outputting the read addresses to the holding means 63, and execution means 65 for reading the processing content corresponding to the address output from the holding means 63 from the first storage means 61 and executing the read processing content.

When the holding means 63 holds no address, the holding means temporarily holds the address read by the reading means 64 and outputs the held address, whereas when the holding means 63 holds the address, the holding means 63 waits for completion of the execution of the processing content by the execution means 65 and outputs the held address after the completion of the execution. As a result, it is possible to reduce the overhead caused by the switching among each process and thereby improve the overall calculation performance.

### First Exemplary Embodiment

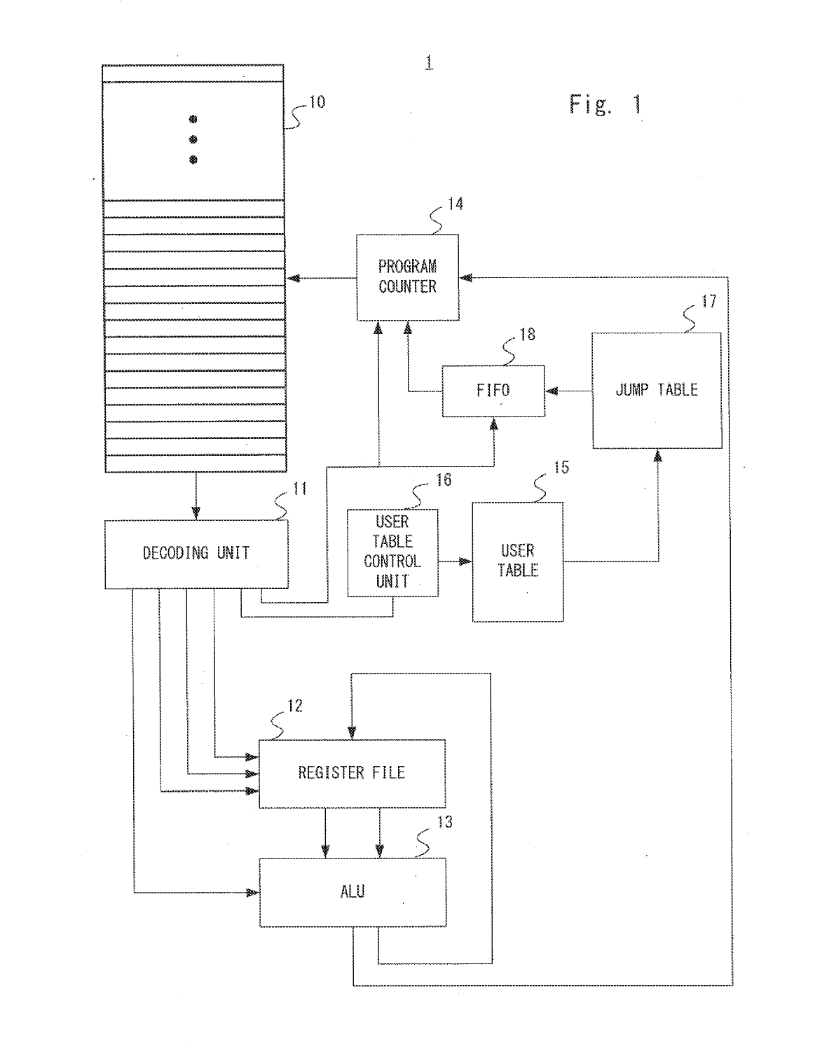

FIG. 1 is a block diagram showing a schematic system configuration of an arithmetic processing device according to a first exemplary embodiment of the present invention. The arithmetic processing device 1 according to this exemplary embodiment includes an instruction memory 10, a decoding unit 11, a register file 12, an ALU 13, a program counter 14, a user table 15, a user table control unit 16, a jump table 17, and a FIFO 18.

The instruction memory 10 is an example of first storage means, and stores a plurality of instructions (processing contents) to be executed for users in a state where the plurality of instructions (processing contents) are associated with addresses. The instruction memory 10 is connected to each of the program counter 14 and the decoding unit 11.

The decoding unit 11 is an example of execution means, and makes the instruction memory 10 read an instruction corresponding to an address output from the FIFO 18 through the program counter 14 and makes the ALU 13 execute the read instruction. The decoding unit 11 analyzes the instruction output from the instruction memory 10, and generates and outputs control signals each of which is used to control a respective one of the register file 12, the ALU 13, the user table control unit 16, and the FIFO 18 connected to the output side of the decoding unit 11. The decoding unit 11 is connected to each of the register file 12, the ALU 13, the user table control unit 16, the FIFO 18, and the program counter 14.

The register file 12 stores data necessary for calculation executed in the ALU 13. The register file 12 is connected to each of the decoding unit 11 and the ALU 13.

The ALU 13 is an arithmetic processing unit that performs actual arithmetic processing according to the control signal from the decoding unit 11 by using data from the register file 12. The ALU 13 is connected to each of the decoding unit 11, the register file 12, and the program counter 14. The register file 12 and the ALU 13 are an example of calculation execution means. Note that the register file 12 and the ALU 13 are not essential components for the present invention, and therefore any arbitrary configuration can be used in place of the above-described configuration.

The program counter 14 is an example of program counter means, and generates an address that is used to read an instruction stored in the instruction memory 10. Further, the program counter 14 has a function of incrementing the address held therein and outputting the incremented address in the next cycle, a function of outputting the same address as the current address in the next address, a function of outputting a value output from the ALU 13 as an address, and a function of updating an address generated by the program counter itself based on an output from the FIFO 18 and outputting the updated address. The program counter 14 is connected to each of the instruction memory 10, the ALU 13, the FIFO 18, and the decoding unit 11.

The user table 15 is an example of user table means, and stores process indexes which are specified for each user, i.e., index information specifying processing contents executed for users. The user table 15 is connected to each of the user table control unit 16 and the jump table 17.

The user table control unit 16 is an example of user table control means, and outputs a process index of a user stored in the user table 15 to the jump table 17 in accordance with a parameter of the control signal output from the decoding unit 11. The user table control unit 16 is connected to each of the decoding unit 11 and the user table 15.

The jump table 17 is an example of second storage means, and stores the first address of an area in the instruction memory 10 where a processing content(s) is stored for each user (hereinafter referred to as “first address”), for each user processing (for each process index). The jump table 17 outputs the first address to the FIFO 18 based on the process index output from the user table. The jump table 17 is connected to each of the user table 15 and the FIFO 18.

The FIFO 18 is an example of holding means, and temporarily holds the first address for each user processing read from the jump table 17. The FIFO 18 is connected to each of the jump table 17, the program counter 14, and the decoding unit 11.

When the FIFO 18 does not hold the first address from the jump table 17 (Empty state), the FIFO 18 temporarily holds the first address read from the jump table 17 and outputs the held first address in the next cycle. On the other hand, when the FIFO 18 holds the first address from the jump table 17 (Non-Empty state), the FIFO 18 waits for the completion of the processing of the sub-program and outputs the first address after the completion of the processing.

Next, an operation of the arithmetic processing device having the above-described configuration is explained in detail with reference to FIGS. 1 to 3.

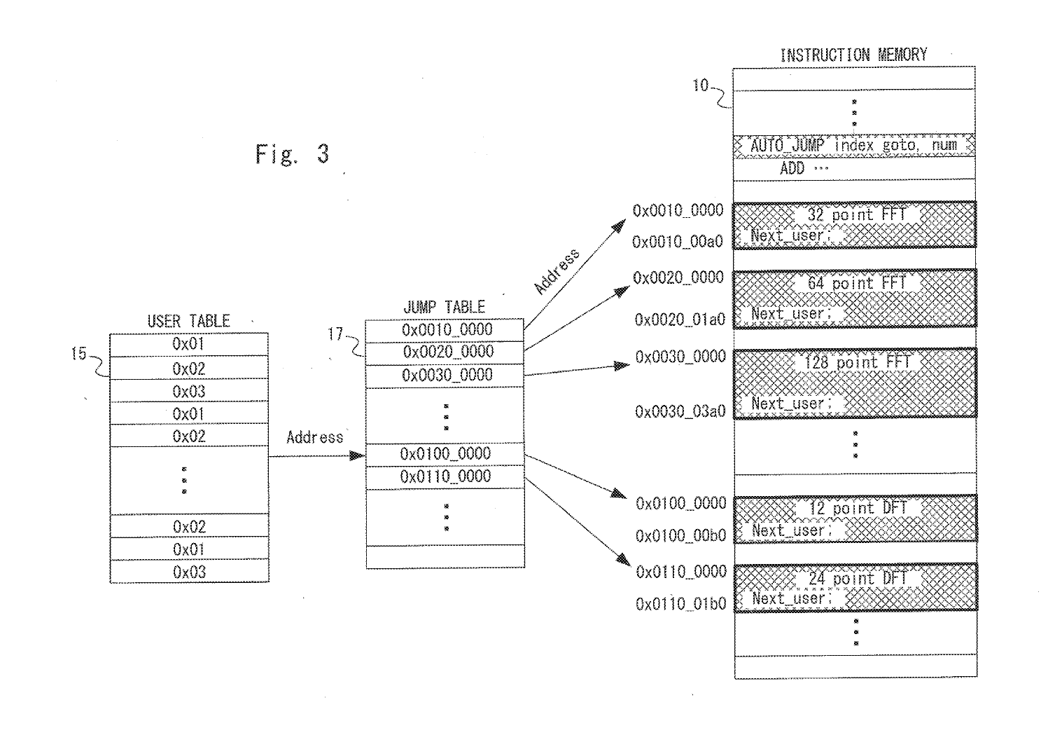

Firstly, as a precondition for the main operation, assume that, for example, at least two types of sub-programs (processing contents) necessary for executing arithmetic processing specified for each user, like the ones shown in the table located on the right side in FIG. 3, and special instructions USER_JUMPs (instruction information) associated with those sub-programs, which are shown on the left of the corresponding sub-programs, are stored in the instruction memory 10. Further, assume that a NEXT_USER instruction indicating the end of a sub-program is always present at the end of the sub-program.

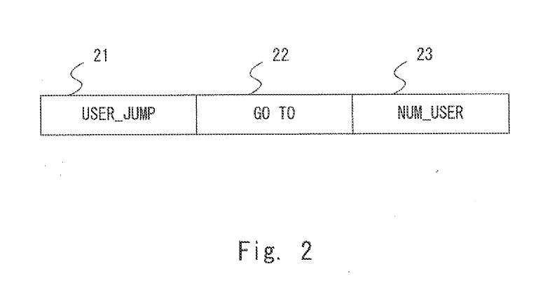

As shown in FIG. 2, the special instruction USER_JUMP consists of, for example, an operation code (USER_JUMP) 21, “GO TO” 22 indicating information of a place (address) at which an instruction that is read after processing corresponding to the desired number of users is completed is stored, and “NUM_USER” 23 indicating the number of users for whom processing should be executed.

As shown in the table located roughly in the middle of FIG. 3, a plurality of first addresses of sub-programs are stored in the jump table 17. Finally, as shown in the table located on the left side in FIG. 3, the same number of process indexes as the number of users are stored in the user table 15. The process indexes indicate which sub-program(s) should be executed for each user.

Next, an operation method for each block of the arithmetic processing device under the aforementioned precondition is explained.

Firstly, the instruction memory 10 reads a special instruction USER_JUMP stored therein and outputs it to the decoding unit 11.

The decoding unit 11 interprets the special instruction USER_JUMP read from the instruction memory 10, generates a control signal based on the interpreted special instruction USER_JUMP, and outputs the generated control signal to the user table control unit 16. Note that the aforementioned control signal contains, for example, a flag for starting data processing for a user(s) and a value indicating the number of users.

Upon receiving the control signal from the decoding unit 11, the user table control unit 16 instructs, for example, the user table 15 to read a process index for the first user from the head thereof.

The process index read from the user table 15 is output to the jump table 17 as the address for the jump table 17. Then, the jump table 17 outputs the first address of the sub-program that is executed as the first user processing stored therein to the FIFO 18.

At this point, when the FIFO 18 is empty (Empty state), the FIFO 18 outputs the first address output from the jump table 17 to the program counter 14 in the next cycle. The program counter 14 updates (i.e., changes) the current address for the instruction memory 10 to the first address received from the FIFO 18 and outputs the updated address to the instruction memory 10.

The instruction memory 10 receives the first address from the program counter 14, reads an instruction of the sub-program specified by that first address (e.g., the first instruction of 32 point FFF calculation in FIG. 3), and outputs the read instruction to the decoding unit 11.

The decoding unit 11 interprets the instruction of the sub-program received from the instruction memory 10, generates control signals for controlling the register file 12 and the ALU 13, and outputs the generated control signals to the register file 12 and the ALU 13. The register file 12 and the ALU 13 execute the sub-program according to the control signals from the decoding unit 11.

On the other hand, when the FIFO 18 is not empty (Non-Empty state) or when the register file 12 and the ALU 13 are executing a sub-program, the FIFO 18 temporarily holds the first address from the jump table 17. Then, when the decoding unit 11 detects a NEXT_USER instruction indicating the end of the sub-program during the execution of the sub-program processing, the decoding unit 11 performs control so that the first address of the sub-program corresponding to the next user, which is temporarily held by the FIFO 18, is output to the program counter 14.

When the FIFO 18 outputs the first address of the sub-program corresponding to the next user to the instruction memory 10 through the program counter 14, the instruction memory 10 reads the first instruction of the sub-program corresponding to the next user and outputs the read first instruction to the decoding unit 11. Then, the decoding unit 11 interprets the instruction read by the instruction memory 10, generates control signals for controlling the register file 12 and the ALU 13, and outputs the generated control signals to the register file 12 and the ALU 13. The register file 12 and the ALU 13 execute the sub-program for the next user (e.g., the first instruction of 64 point FFF calculation in FIG. 3). The above-described series of processes is repeated as many times as the number of users or the number of tasks. In this manner, it is possible to perform repetitive processing by setting appropriate values in the field indicating whether the instruction is repeatedly executed or not and in the field specifying the number of repetitions without using the conventional loop control instruction. As a result, since the number of instructions output from the instruction memory 10 can be reduced, the power consumption can be reduced and the deterioration in the execution speed can be prevented.

As described above, according to the arithmetic processing device 1 in accordance with the first exemplary embodiment, it is possible to generate the first address of a sub-program for each process as many times as the number of users in succession by using the user table 15 and the jump table 17. Further, the FIFO 18 temporarily stores the generated first address and outputs the first address of the instruction to be executed next to the instruction memory 10 through the program counter 14 at the timing at which the NEXT_USER instruction by which the execution of the sub-program is finished is detected. As a result, it is possible to reduce the overhead caused by the switching among users and thereby improve the overall calculation performance.

### Second Exemplary Embodiment

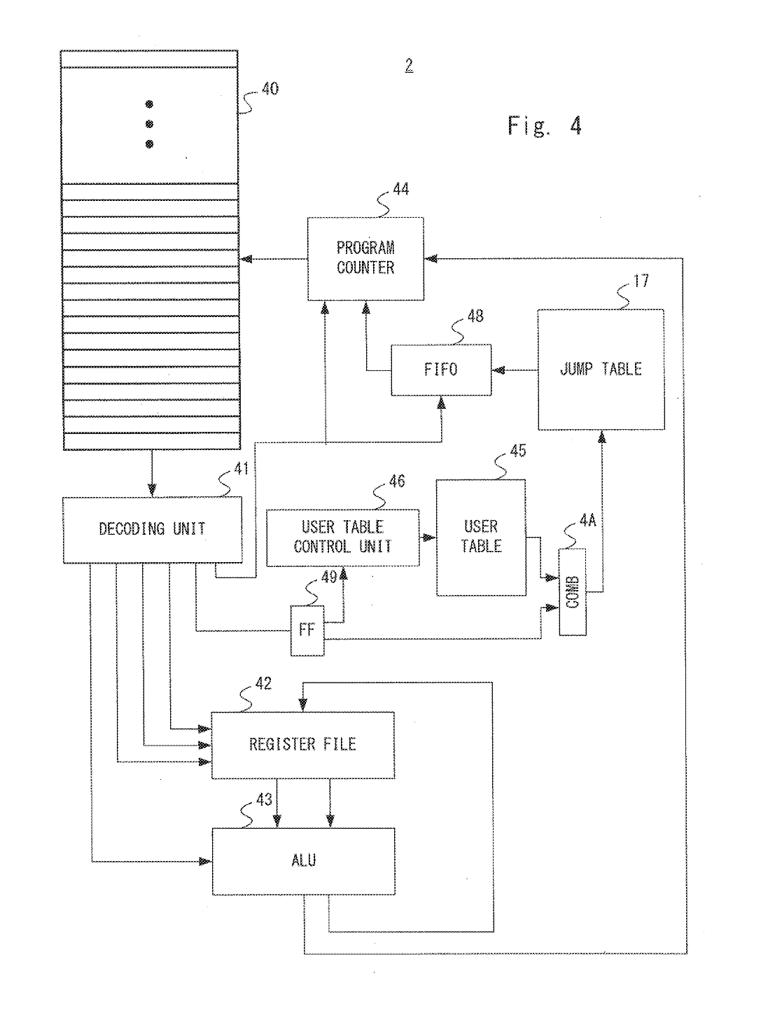

An arithmetic processing device 2 according to a second exemplary embodiment of the present invention is explained in detail with reference to FIGS. 4 to 6. In the arithmetic processing device 1 according to the above-described first exemplary embodiment, there are two types of arguments in the special instruction USER_JUMP, i.e., the “GO TO” value indicating the destination of the program counter value at the end of the processing for all the users and the “NUM_USER” value indicating the number of users (see FIG. 2). In contrast to this, in the arithmetic processing device 2 according to the second exemplary embodiment, the special instruction USER_JUMP includes an index (INDEX) value that enables a larger range of processing to be broadly divided in addition to the “GO TO” value and the “NUM_USER” value. The arithmetic processing device 2 according to the second exemplary embodiment is different from the arithmetic processing device 1 according to the first exemplary embodiment in this point.

Firstly, differences between the configuration of the arithmetic processing device according to the second exemplary embodiment and that of the first exemplary embodiment are explained in detail with reference to FIG. 4. While the user table 15 is directly connected to the jump table 17 in the arithmetic processing device 1 according to the above-described first exemplary embodiment, the arithmetic processing device 2 according to the second exemplary embodiment further includes an FF 49 for storing an index value and a COMB part 4A that generates a new index value and outputs the generated index value to the jump table 47.

The FF 49 is an example of third storage means, and stores an index value together with a control signal for controlling the user table control unit 46 output from the decoding unit 41. The COMB part 4A is an example of index generation means, and generates a new index by combining the index value stored in the FF 49 with the process index for each user read from the user table 45 and outputs the generated index to the jump table 47.

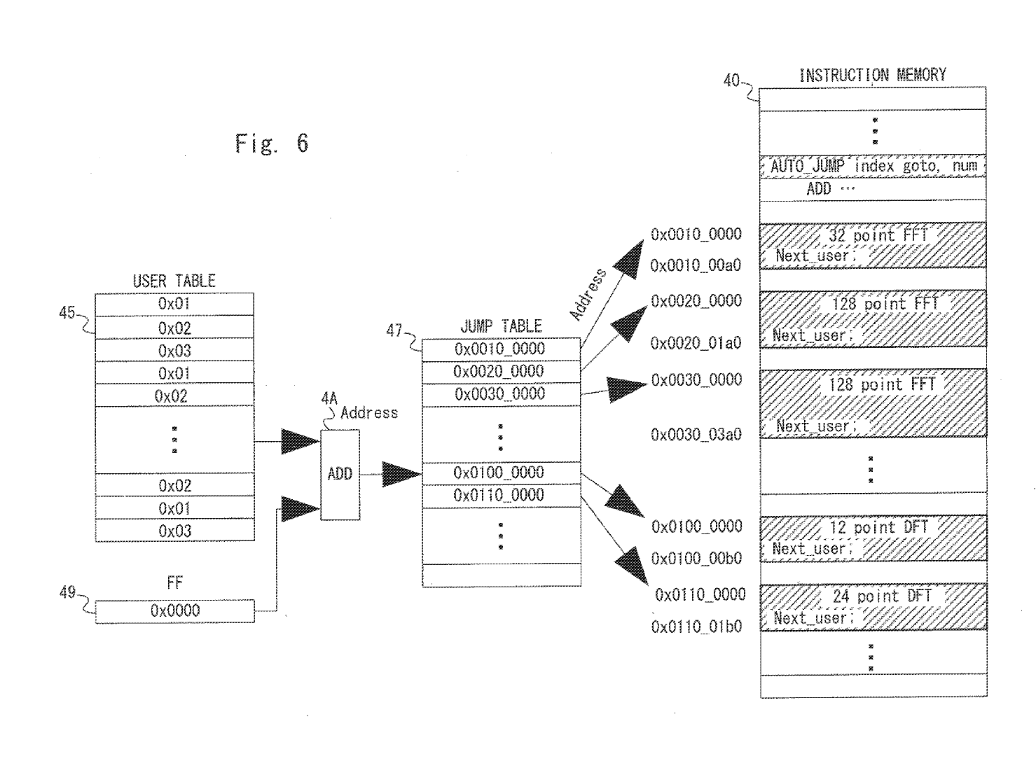

Next, an operation of the arithmetic processing device according to the second exemplary embodiment is explained in detail with reference to FIGS. 4 and 6. Firstly, as a precondition for the main operation, assume that, for example, at least two types of sub-programs necessary for executing arithmetic processing specified for each user, like the ones shown in the table on the right side in FIG. 6, and special instructions USER_JUMPs, which are shown on the left of the sub-programs, are stored in the instruction memory 40.

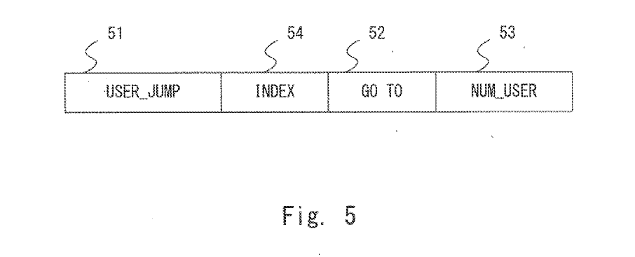

Further, assume that a NEXT_USER instruction indicating the end of a sub-program is always present at the end of the sub-program. As shown in FIG. 5, the special instruction USER_JUMP consists of, for example, an operation code (USER_JUMP) 51, “GO TO” 52 indicating a place (address) at which an instruction that is read after processing corresponding to the desired number of users is completed is stored, “NUM_USER” 53 indicating the number of users for whom processing should be executed, and index (INDEX) information 54 by which processing that is collectively performed for all the users at once can be specified.

As shown in the table located roughly in the middle in FIG. 6, a plurality of first addresses of sub-programs are stored in the jump table 47. As shown in the table located on the left side in FIG. 6, the same number of process indexes as the number of users are stored in the user table 45. The process indexes indicate which sub-program(s) should be executed for each user.

An operation of the arithmetic processing device having the above-described configuration is explained in detail.

Firstly, the instruction memory 40 reads a special instruction USER_JUMP stored therein and outputs it to the decoding unit 41. The decoding unit 41 interprets the instruction read from the instruction memory 40 and outputs a control signal for controlling the user table control unit 46 and an index value to the user table control unit 46 and the FF 49, respectively. Note that the aforementioned control signal contains a flag for starting processing for a user(s) and a value indicating the number of users.

Upon receiving the control signal from the decoding unit 41, the user table control unit 46 instructs the user table 45 to read a process index for the first user from the head thereof. The COMB 4A generates a new index value by combining the process index read from the user table 45 with the index value stored in the FF 49, and outputs the generated index value to the jump table 47. Then, the jump table 47 outputs the first address of the sub-program to be executed as the first user processing stored therein to the FIFO 48.

At this point, when the FIFO 48 is empty (Empty state), the first address output from the jump table 47 to the FIFO 48 is output to the program counter 44 in the next cycle. The program counter 44 updates (i.e., changes) the current address for the instruction memory 40 to the first address received from the FIFO 48 and outputs the updated address to the instruction memory 40. Upon receiving the address from the program counter 44, the instruction memory 40 reads the sub-program specified by the address.

When the instruction memory 40 reads an instruction of the sub-program and outputs the read instruction to the decoding unit 41, the decoding unit 41 interprets that instruction, generates control signals for controlling the register file 42 and the ALU 43, and outputs the generated control signals to the register file 42 and the ALU 43. Upon receiving the control signals from the decoding unit 41, the register file 42 and the ALU 43 execute the sub-program.

On the other hand, when the FIFO 48 is not empty (Non-Empty state) or when the register file 42 and the ALU 43 are executing a sub-program, the first address output from the jump table 47 to the FIFO 48 is temporarily held in the FIFO 48. When the decoding unit 41 detects a NEXT_USER instruction indicating the end of the sub-program during the execution of the sub-program processing, the decoding unit 41 performs control so that the first address of the sub-program corresponding to the next user, which is temporarily held by the FIFO 48, is output to the program counter 44.

The first address of the sub-program corresponding to the next user is output from the FIFO 48 to the program counter 44, and the first instruction of the sub-program corresponding to the next user is read and output from the instruction memory 40.

The decoding unit 41 interprets the instruction read from the instruction memory 40, generates control signals for controlling the register file 42 and the ALU 43, and outputs the generated control signals to the register file 42 and the ALU 43. Upon receiving the control signals from the decoding unit 41, the register file 42 and the ALU 43 execute the sub-program for the next user. The above-described series of processes is repeated as many times as the number of users. Note that similarly to the above-described first exemplary embodiment, the register file 42 and the ALU 43 are not essential components for the present invention in the second exemplary embodiment, and therefore any arbitrary configuration can be used in place of the above-described configuration.

As described above, according to the arithmetic processing device 2 in accordance with the second exemplary embodiment, it is possible to generate the first address of a sub-program for each user as many times as the number of users in succession by using the user table 45 and the jump table 47. Further, the FIFO 48 temporarily stores the generated first address and outputs the first address of the instruction to be executed next to the instruction memory 40 through the program counter 44 at the timing at which the NEXT_USER instruction by which the execution of the sub-program is finished is detected. As a result, it is possible to reduce the overhead caused by the switching among each process and thereby improve the overall calculation performance.

Further, the special instruction USER_JUMP contains an index value by which processing that is performed for all the users can be specified as an argument. As a result, it is possible to execute a plurality of types of processes for each user (for example, a case where after executing FFTs whose points differ from one user to another for all the users, FFTs whose points differ from one user to another are performed for the users) by changing the index value and the “GO TO” value, which are arguments of the special instruction, without changing the contents of the user table 45. Consequently, a secondary advantageous effect that the memory size can be reduced is achieved.

### Third Exemplary Embodiment

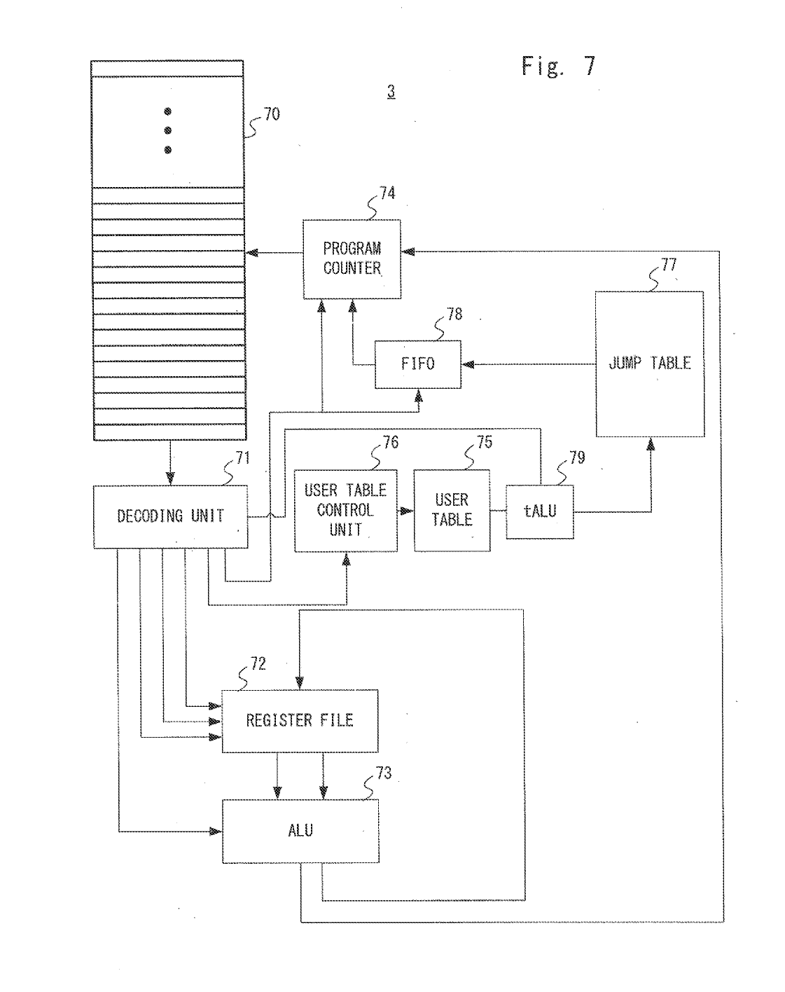

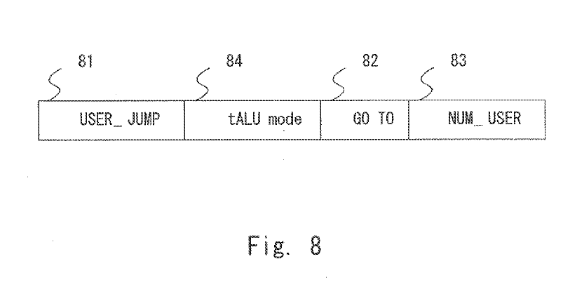

An arithmetic processing device according to a third exemplary embodiment of the present invention is explained in detail with reference to FIGS. 7 and 8. In the arithmetic processing device 1 according to the above-described first exemplary embodiment, the user table 15 is directly connected to the jump table 17. In contrast to this, the arithmetic processing device 3 according to the third exemplary embodiment is different from the arithmetic processing device 1 according to the first exemplary embodiment in that the arithmetic processing device 3 further includes a tALU 79 disposed between the user table 75 and the jump table 77. The tALU 79 is an example of calculation means, and is an arithmetic unit, for example, capable of performing an arithmetic process such as a constant division, a constant multiplication, and a constant addition.

Further, in the arithmetic processing device 1 according to the above-described first exemplary embodiment, there are two types of arguments in the special instruction USER_JUMP, i.e., the “GO TO” value indicating the destination of the program counter value at the end of the processing for all the users and the “NUM_USER” value indicating the number of users. In contrast to this, in the arithmetic processing device 3 according to the third exemplary embodiment, a tALU_mode (an example of calculation mode information) 84 for specifying the calculation mode of the tALU 79 is added in the special instruction USER_JUMP in addition to the “GO TO” value and the “NUM_USER” value as shown in FIG. 8.

Next, an operation of the arithmetic processing device according to the third exemplary embodiment is explained in detail.

Firstly, as a precondition for the main operation, assume that at least two types of sub-programs necessary for executing arithmetic processing specified for each user and special instructions USER_JUMPs are stored in the instruction memory 70 as in the case of the above-described first exemplary embodiment. Further, assume that a NEXT_USER instruction indicating the end of a sub-program is always present at the end of the sub-program. Further, as shown in FIG. 8, the special instruction USER_JUMP consists of, for example, an operation code (USER_JUMP) 81, “GO TO” 82 indicating a place (address) at which an instruction that is read after processing corresponding to the desired number of users is completed is stored, “NUM_USER” 83 indicating the number of users for whom processing should be executed, and a tALU_mode 84 for specifying the calculation mode of the tALU 79.

Similarly to the above-described first exemplary embodiment, a plurality of first addresses of sub-programs are stored in the jump table 77. Note that similarly to the above-described first exemplary embodiment, the same number of process indexes as the number of users are stored in the user table 75. The process indexes indicate which sub-program(s) should be executed for each user.

Under the above-described precondition, the arithmetic processing device 3 according to this exemplary embodiment operates as follows. Firstly, the instruction memory 70 reads a special instruction USER_JUMP stored therein and outputs it to the decoding unit 71.

Next, the decoding unit 71 interprets the instruction read from the instruction memory 70 and outputs a control signal for controlling the user table control unit 76 and a tALU_mode value for specifying the calculation mode of the tALU to the user table control unit 76 and the tALU 79, respectively. Note that the aforementioned control signal contains a flag for starting processing for a user(s) and a value indicating the number of users.

Upon receiving the control signal from the decoding unit 71, the user table control unit 76 instructs the user table 75 to read a process index for the first user from the head thereof and output the read process index to the tALU 79.

The tALU 79 performs arithmetic processing specified by the previously-input tALU_mode for the process index. The tALU 79 outputs the result of that arithmetic processing to the jump table 77. The jump table 77 outputs the first address of the sub-program that is executed as the first user processing stored therein to the FIFO 78.

Note that when the FIFO 78 is empty (Empty state), the FIFO 78 outputs the first address output from the jump table 77 to the program counter 74 in the next cycle.

The program counter 74 updates (i.e., changes) the current address for the instruction memory 70 to the first address received from the FIFO 78 and outputs the updated first address to the instruction memory 70. Upon receiving the first address from the program counter 74, the instruction memory 70 reads an instruction included in the sub-program specified by that first address and outputs the read instruction to the decoding unit 71.

The decoding unit 71 interprets the instruction of the sub-program read from the instruction memory 70, generates control signals for controlling the register file 72 and the ALU 73, and outputs the generated control signals to the register file 72 and the ALU 73. The register file 72 and the ALU 73 execute the sub-program according to the control signals from the decoding unit 71.

Note that when the FIFO 78 is not empty (Non-Empty state) or when the register file 72 and the ALU 73 are executing a sub-program, the FIFO 78 temporarily holds the first address output from the jump table 77.

When the decoding unit 71 detects a NEXT_USER instruction indicating the end of the sub-program during the execution of the sub-program processing, the decoding unit 71 performs control so that the first address of the sub-program corresponding to the next user, which is temporarily held by the FIFO 78, is output to the program counter 74.

The FIFO 78 outputs the first address of the sub-program corresponding to the next user to the program counter 74. The program counter 74 outputs the first address received from the FIFO 78 to the instruction memory 70. The instruction memory 70 reads the first instruction of the sub-program corresponding to the next user and outputs the read first instruction to the decoding unit 71.

The decoding unit 71 interprets the instruction read by the instruction memory 70, generates control signals for controlling the register file 72 and the ALU 73, and outputs the generated control signals to the register file 72 and the ALU 73. The register file 72 and the ALU 73 execute the sub-program for the next user according to the control signals from the decoding unit 71. The above-described series of processes is repeated as many times as the number of users. Note that similarly to the above-described first exemplary embodiment, the register file 72 and the ALU 73 are not essential components for the present invention in the third exemplary embodiment, and therefore any arbitrary configuration can be used in place of the above-described configuration.

As described above, according to the arithmetic processing device 3 in accordance with the third exemplary embodiment, it is possible to generate the first address of a sub-program for each user as many times as the number of users in succession by using the user table 75 and the jump table 77. Further, the FIFO 78 temporarily stores the generated first address and outputs the first address of the instruction to be executed next to the instruction memory 70 through the program counter 74 at the timing at which the NEXT_USER instruction with which the execution of the sub-program is finished is detected. As a result, it is possible to reduce the overhead caused by the switching among each process and thereby improve the overall calculation performance.

Further, the tALU 79 that can perform arithmetic processing for an index value is disposed between the user table 75 and the jump table 77. This configuration provides a secondary advantageous effect that an index value can be obtained from the number of data provided to a user(s) or the like without converting a parameter(s) for each user stored in the user table 75 into an index value in advance.

### Fourth Exemplary Embodiment

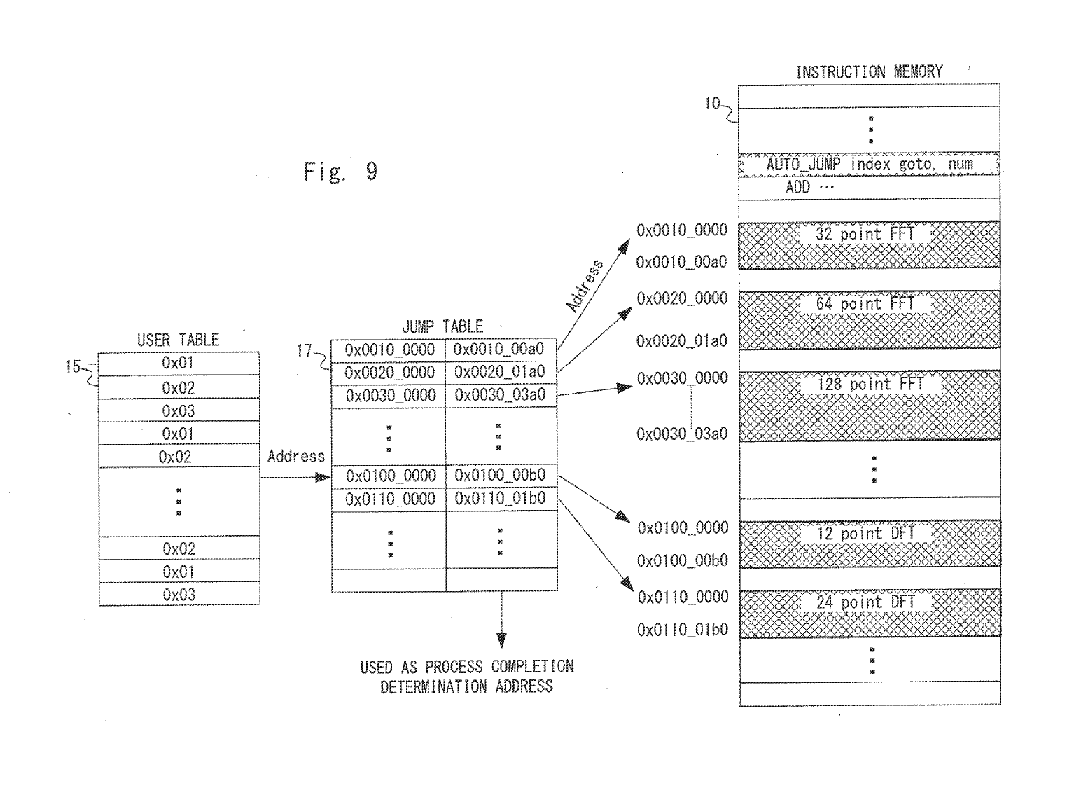

An arithmetic processing device 1 according to a fourth exemplary embodiment of the present invention is explained in detail with reference to FIG. 9.

In the arithmetic processing device 1 according to the above-described first exemplary embodiment, the NEXT_USER instruction indicating the end of a sub-program is inserted at the end of the program stored in the instruction memory 10 and the control for switching among sub-programs for respective users is performed based on this instruction. In contrast to this, in the arithmetic processing device 1 according to the above-described fourth exemplary embodiment, the NEXT_USER instruction indicating the end of the program is not inserted at the end of the sub-program and the first address and the last address are stored for each sub-program in the jump table 17 as shown in FIG. 9. The arithmetic processing device 1 according to the fourth exemplary embodiment is different from the arithmetic processing device 1 according to the above-described first exemplary embodiment in this point.

Note that the hardware configuration of the arithmetic processing device 1 according to the fourth exemplary embodiment is roughly the same as that of the arithmetic processing device 1 according to the above-described first exemplary embodiment, and therefore the same symbols are assigned to the same components/structures. Further, their detailed explanation is omitted.

Further, as for the control for switching among sub-programs, the decoding unit 11 interprets the NEXT_USER instruction and controls the FIFO 18 and the program counter 14 in the arithmetic processing device 1 according to the above-described first exemplary embodiment. In contrast to this, in the arithmetic processing device 1 according to the fourth exemplary embodiment, the value of the program counter 14 (hereinafter called “program counter value”) is compared with the last address read from the jump table 17. Then, when the program counter value is smaller than the last address, the program counter value is updated as usual. On the other hand, when the program counter value is equal to the last address, the next program counter value is updated (i.e., change) to the address output from the FIFO 18. Note that the other operations of the arithmetic processing device 1 according to the fourth exemplary embodiment are roughly the same as those of the arithmetic processing device 1 according to the above-described first exemplary embodiment, and therefore their explanation is omitted.

As described above, according to the arithmetic processing device 1 according to the fourth exemplary embodiment, it is possible to reduce the overhead caused by switching among each process and thereby improve the overall calculation performance as in the case of the arithmetic processing device 1 according to the above-described first exemplary embodiment.

### Fifth Exemplary Embodiment

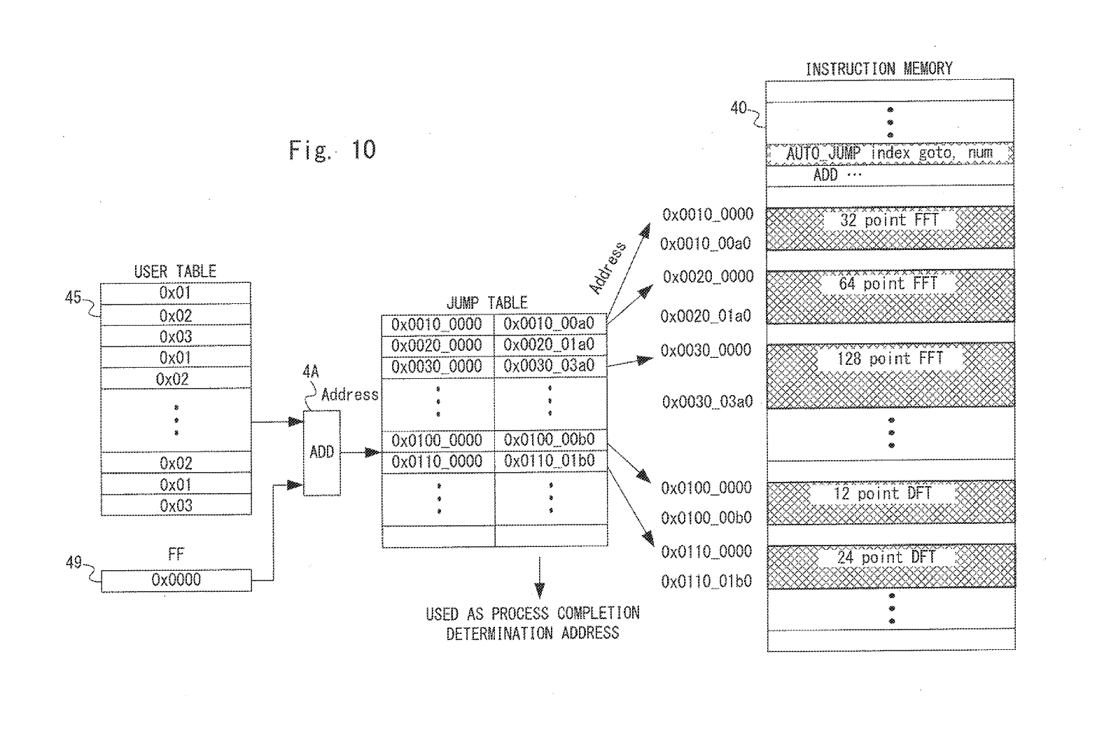

An arithmetic processing device according to a fifth exemplary embodiment of the present invention is explained in detail with reference to FIG. 10.

In the arithmetic processing device 2 according to the above-described second exemplary embodiment, the NEXT_USER instruction indicating the end of the program is inserted at the end of the sub-program stored in the instruction memory 40 and the control for switching among sub-programs for respective users is performed based on this instruction. In contrast to this, in the arithmetic processing device 2 according to the above-described fifth exemplary embodiment, the NEXT_USER instruction indicating the end of a sub-program is not inserted at the end of the program. Instead, the first address and the last address are stored for each sub-program in the jump table as shown in FIG. 10. The arithmetic processing device 2 according to the fifth exemplary embodiment is different from the arithmetic processing device 2 according to the above-described second exemplary embodiment in this point.

Note that the hardware configuration of the arithmetic processing device 2 according to the fifth exemplary embodiment is roughly the same as that of the arithmetic processing device 2 according to the above-described second exemplary embodiment, and therefore the same symbols are assigned to the same components/structures. Further, their detailed explanations are omitted.

Further, as for the control for switching among sub-programs, the decoding unit 41 interprets the NEXT_USER instruction and the FIFO 48 and the program counter 44 are controlled in the arithmetic processing device 2 according to the above-described second exemplary embodiment. In contrast to this, in the arithmetic processing device 2 according to the fifth exemplary embodiment, the program counter value is compared with the last address read from the jump table 47. When the program counter value is smaller than the last address, the program counter value is updated as usual. On the other hand, when the program counter value is equal to the last address, the next program counter value is updated (i.e., change) to the address output from the FIFO 48.

Note that the other operations of the arithmetic processing device 2 according to the fifth exemplary embodiment are roughly the same as those of the arithmetic processing device 2 according to the above-described second exemplary embodiment, and therefore their explanations are omitted.

As described above, according to the arithmetic processing device 2 according to the fifth exemplary embodiment, it is possible to reduce the overhead caused by the switching among each process and thereby improve the overall calculation performance as in the case of the arithmetic processing device 2 according to the above-described second exemplary embodiment.

Note that the present invention is not limited to the above-described exemplary embodiments, and various modifications can be made as appropriate without departing from the spirit of the present invention.

Although the present invention is described as a hardware configuration in the above-described exemplary embodiments, the present invention is not limited to the hardware configurations. For example, in the present invention, any of the processes that are executed by the above-described decoding units 11, 41 and 71 and the user table control units 16, 46 and 76 can be also implemented by causing a CPU to execute a computer program.

The program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM, a CD-R, and a CD-R/W, and a semiconductor memory (such as a mask ROM, a PROM (Programmable ROM), an EPROM (Erasable PROM), a flash ROM, and a RAM). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

The whole or part of the exemplary embodiments disclosed above can be described as, but not limited to, the following supplementary notes.

### (Supplementary Note 1)

An arithmetic processing device comprising:

first storage means for storing a plurality of processing contents in a state where the plurality processing contents are associated with addresses;

second storage means for storing each of the addresses of the plurality of processing contents stored in the first storage means;

holding means for temporarily holding the address;

reading means for successively reading the addresses stored in the second storage means and outputting the read addresses to the holding means; and

execution means for reading the processing content corresponding to the address output from the holding means from the first storage means and executing the read processing content, wherein

when the holding means holds no address, the holding means temporarily holds the address read by the reading means and outputs the held address, whereas when the holding means holds the address, the holding means waits for completion of the execution of the processing content by the execution means and outputs the held address after the completion of the execution.

### (Supplementary Note 2)

The arithmetic processing device described in Supplementary note 1, wherein instruction information including information of an address at which an instruction to be read after processing for a desired number of users is completed is stored and information indicating the number of users for whom processing is performed is stored in association with the processing content in the first storage means.

### (Supplementary Note 3)

The arithmetic processing device described in Supplementary note 1 or 2, wherein

the reading means comprises user table means for storing index information for specifying the processing content to be executed for a user, and user table control means for outputting the index information stored in the user table means to the second storage means, and

the second storage means outputs an address corresponding to the index information output from the user table means to the holding means.

### (Supplementary Note 4)

The arithmetic processing device described in Supplementary note 3, wherein

instruction information including information of an address at which an instruction to be read after processing for a desired number of users is completed is stored, information indicating the number of users for whom processing is performed, and index information by which processing that is collectively performed for all users at once can be specified is stored in the first storage means,

the arithmetic processing device further comprises:

third storage means for storing a control signal for controlling the user table control means and the index information, the control signal being output from the execution means; and

index generation means for generating new index information based on the index information stored in the user table means and the index information stored in the third storage means, and

the new index information generated by the index generation means is output to the second storage means.

### (Supplementary Note 5)

The arithmetic processing device described in Supplementary note 3, further comprising calculation means for performing arithmetic processing for the index information stored in the user table means, wherein

the calculation means outputs the index information for which the arithmetic processing is performed to the second storage means.

### (Supplementary Note 6)

The arithmetic processing device described in Supplementary note 5, wherein instruction information including at least information of an address at which an instruction to be read after processing for a desired number of users is completed is stored, information indicating the number of users for whom processing is performed, and calculation mode information for determining a calculation content of the calculation means is stored in the first storage means.

### (Supplementary Note 7)

The arithmetic processing device described in any one of Supplementary notes 1 to 6, further comprising:

program counter means connected to the holding means; and

calculation execution means for executing arithmetic processing according to an instruction from the execution means, wherein

the program counter means includes a function of incrementing an address held therein and outputting the incremented address to the first storage means in a next cycle, a function of outputting the same address to the first storage means in the next cycle, a function of outputting an value output from the calculation execution means as an address, and a function of updating an address generated based on a value output from the holding means and outputting the updated address.

### (Supplementary Note 8)

An arithmetic processing method for an arithmetic processing device,

the arithmetic processing device comprising:

first storage means for storing a plurality of processing contents in a state where the plurality processing contents are associated with addresses;

second storage means for storing each of the addresses of the plurality of processing contents stored in the first storage means; and

holding means for temporarily holding the address,

the arithmetic processing method comprising:

a step of successively reading the addresses stored in the second storage means and outputting the read addresses to the holding means;

a step of reading the processing content corresponding to the address output from the holding means from the first storage means and executing the read processing content; and

a step of, when the holding means holds no address, temporarily holding the read address and outputting the held address, and when the holding means holds the address, waiting for completion of the execution of the processing content and outputting the held address after the completion of the execution.

### (Supplementary Note 9)

The arithmetic processing method for an arithmetic processing device described in Supplementary note 8, wherein instruction information including information of an address at which an instruction to be read after processing for a desired number of users is completed is stored and information indicating the number of users for whom processing is performed is stored in association with the processing content in the first storage means.

### (Supplementary Note 10)

The arithmetic processing method for an arithmetic processing device described in Supplementary note 8 or 9, further comprising:

a step of storing index information for specifying the processing content to be executed for a user;

a step of outputting the stored index information to the second storage means; and

a step of outputting an address corresponding to the output index information to the holding means.

### (Supplementary Note 11)

The arithmetic processing method for an arithmetic processing device described in Supplementary note 10, wherein

instruction information including information of an address at which an instruction to be read after processing for a desired number of users is completed is stored, information indicating the number of users for whom processing is performed, and index information by which processing that is collectively performed for all users at once can be specified is stored in the first storage means,

the arithmetic processing device further comprises third storage means for storing a control signal output from the execution means and the index information, and

the arithmetic processing method further comprises: a step of generating new index information based on the stored index information and the index information stored in the third storage means; and

a step of outputting the generated new index information to the second storage means.

### (Supplementary Note 12)

The arithmetic processing method for an arithmetic processing device described in Supplementary note 10, further comprising:

a step of performing arithmetic processing for the stored index information; and

a step of outputting the index information for which the arithmetic processing is performed to the second storage means.

### (Supplementary Note 13)

The arithmetic processing method for an arithmetic processing device described in Supplementary note 12, wherein instruction information including at least information of an address at which an instruction to be read after processing for a desired number of users is completed is stored, information indicating the number of users for whom processing is performed, and calculation mode information for determining a calculation content of the calculation means is stored in the first storage means.

### (Supplementary Note 14)

The arithmetic processing method for an arithmetic processing device described in any one of Supplementary notes 9 to 13, wherein

the arithmetic processing device further comprises program counter means connected to the holding means, and calculation execution means for executing arithmetic processing according to an instruction from the execution means, and

the program counter means includes a function of incrementing an address held therein and outputting the incremented address to the first storage means in a next cycle, a function of outputting the same address to the first storage means in the next cycle, a function of outputting an value output from the calculation execution means as an address, and a function of updating an address generated based on a value output from the holding means and outputting the updated address.

### (Supplementary Note 15)

An arithmetic processing program for an arithmetic processing device,

the arithmetic processing device comprising:

first storage means for storing a plurality of processing contents in a state where the plurality processing contents are associated with addresses;

second storage means for storing each of the addresses of the plurality of processing contents stored in the first storage means; and

holding means for temporarily holding the address,

the arithmetic processing program causing a computer to execute:

a process of successively reading the addresses stored in the second storage means and outputting the read addresses to the holding means;

a process of reading the processing content corresponding to the address output from the holding means from the first storage means and executing the read processing content; and

a process of, when the holding means holds no address, temporarily holding the read address and outputting the held address, and when the holding means holds the address, waiting for completion of the execution of the processing content and outputting the held address after the completion of the execution.

### INDUSTRIAL APPLICABILITY

The present invention can be used for, for example, an arithmetic processing device that switches the type of processing for a plurality of users or tasks by using a parameter(s) existing for each user or each task.

This application is based upon and claims the benefit of priority from Japanese patent application No. 2012-079359, filed on Mar. 30, 2012, the disclosure of which is incorporated herein in its entirety by reference.

### REFERENCE SIGNS LIST

1, 2, 3 ARITHMETIC PROCESSING DEVICE
10, 40, 70 INSTRUCTION MEMORY
11, 41, 71 DECODING UNIT
12, 42, 72 REGISTER FILE
13, 43, 73 ALU
14, 44, 74 PROGRAM COUNTER
15, 45, 75 USER TABLE
16, 46, 76 USER TABLE CONTROL UNIT
17, 47, 77 JUMP TABLE
18, 48, 78 FIFO
49 FF
4A COMB PART
79 tALU

1. An arithmetic processing device comprising:
a first storage for storing a plurality of processing contents in a state where the plurality processing contents are associated with addresses;
a second storage for storing each of the addresses of the plurality of processing contents stored in the first storage;
a holding portion for temporarily holding the address;
a reading portion for successively reading the addresses stored in the second storage and outputting the read addresses to the holding portion; and
an execution portion for reading the processing content corresponding to the address output from the holding portion from the first storage and executing the read processing content, wherein
when the holding portion holds no address, the holding portion temporarily holds the address read by the reading portion and outputs the held address, whereas when the holding portion holds the address, the holding portion waits for completion of the execution of the processing content by the execution portion and outputs the held address after the completion of the execution.

2. The arithmetic processing device according to claim 1, wherein instruction information including information of an address at which an instruction to be read after processing for a desired number of users is completed is stored and information indicating the number of users for whom processing is performed is stored in association with the processing content in the first storage.

3. The arithmetic processing device according to claim 1, wherein
the reading portion comprises user a table portion for storing index information for specifying the processing content to be executed for a user, and an user table control portion for outputting the index information stored in the user table portion to the second storage, and
the second storage outputs an address corresponding to the index information output from the user table portion to the holding portion.

4. The arithmetic processing device according to claim 3, wherein instruction information including information of an address at which an instruction to be read after processing for a desired number of users is completed is stored, information indicating the number of users for whom processing is performed, and index information by which processing that is collectively performed for all users at once can be specified is stored in the first storage,
the arithmetic processing device further comprises:
a third storage for storing a control signal for controlling the user table control portion and the index information, the control signal being output from the execution portion; and
an index generation portion for generating new index information based on the index information stored in the user table portion and the index information stored in the third storage, and
the new index information generated by the index generation portion is output to the second storage.

5. The arithmetic processing device according to claim 3, further comprising a calculation portion for performing arithmetic processing for the index information stored in the user table portion, wherein
the calculation portion outputs the index information for which the arithmetic processing is performed to the second storage.

6. The arithmetic processing device according to claim 5, wherein instruction information including at least information of an address at which an instruction to be read after processing for a desired number of users is completed is stored, information indicating the number of users for whom processing is performed, and calculation mode information for determining a calculation content of the calculation portion is stored in the first storage.

7. The arithmetic processing device according to claim 1, further comprising:
a program counter connected to the holding portion; and
a calculation execution portion for executing arithmetic processing according to an instruction from the execution portion, wherein
the program counter includes a function of incrementing an address held therein and outputting the incremented address to the first storage in a next cycle, a function of outputting the same address to the first storage in the next cycle, a function of outputting an value output from the calculation execution portion as an address, and a function of updating an address generated based on a value output from the holding portion and outputting the updated address.

8. An arithmetic processing method for an arithmetic processing device,
the arithmetic processing device comprising:
a first storage for storing a plurality of processing contents in a state where the plurality processing contents are associated with addresses;
a second storage for storing each of the addresses of the plurality of processing contents stored in the first storage; and
a holding portion for temporarily holding the address,
the arithmetic processing method comprising:
successively reading the addresses stored in the second storage and outputting the read addresses to the holding portion;
reading the processing content corresponding to the address output from the holding portion from the first storage and executing the read processing content; and
when the holding portion holds no address, temporarily holding the read address and outputting the held address, and when the holding portion holds the address, waiting for completion of the execution of the processing content and outputting the held address after the completion of the execution.

9. A recording medium storing an arithmetic processing program for an arithmetic processing device,
the arithmetic processing device comprising:
a first storage for storing a plurality of processing contents in a state where the plurality of processing contents are associated with addresses;
a second storage for storing each of the addresses of the plurality of processing contents stored in the first storage; and
holding portion for temporarily holding the address,
the arithmetic processing program causing a computer to execute:
a process of successively reading the addresses stored in the second storage and outputting the read addresses to the holding portion;
a process of reading the processing content corresponding to the address output from the holding portion from the first storage and executing the read processing content; and
a process of, when the holding portion holds no address, temporarily holding the read address and outputting the held address, and when the holding portion holds the address, waiting for completion of the execution of the processing content and outputting the held address after the completion of the execution.
